(19) United States
(12) Patent Application Publication
(10) Pub. No.: US 2025/0370773 A1
(43) Pub. Date: Dec. 4, 2025

(54) Semantic Target Identification for User Interface (UI) Automation

(71) Applicant: UiPath Inc., New York, NY (US)

(72) Inventors: Gheorghe C. STAN, Bucuresti (RO); Ion MIRON, Bucuresti (RO)

(21) Appl. No.: 18/731,727

(22) Filed: Jun. 3, 2024

(51) Int. Cl. G06F 9/451

(52) U.S. Cl. CPC G06F 9/451

(57) ABSTRACT

Some embodiments automatically identify a target of a robotic process automation (RPA) activity (e.g., a button to click, an input field to fill out) according to a semantic similarity between a design-time label of the target and a label of a target candidate selected from a runtime instance of the target UI. Semantic similarity herein denotes likeness of meaning, as opposed to wording. Some embodiments employ a language model (LM) to quantify semantic similarity.

### BACKGROUND OF THE INVENTION

The invention relates to robotic process automation (RPA), and in particular to improving target identification in user interface (UI) automation.

RPA is an emerging field of information technology aimed at improving productivity by automating repetitive computing tasks, thus freeing human operators to perform more intellectually sophisticated and/or creative activities. Notable tasks targeted for automation include extracting structured data from documents and web pages and interacting with user interfaces, for instance filling forms and manipulating spreadsheets, among others.

Automating interactions with a user interface poses specific technical problems, such as unambiguously identifying the target of a robotic activity (e.g., a specific button to click, a specific form field to fill in, etc.). When designing an RPA workflow, a target UI element may be specified via a set of programmatic and/or visual characteristics of the respective element. Programmatic characteristics may include, for instance, a set of attribute-value pairs characterizing the position of the respective element within a programmatic representation of the respective UI, such as a UI tree or document object model (DOM). Exemplary visual characteristics may include a position of the respective element relative to other elements of the UI, a color, and a label of the respective element.

However, the target UI (e.g., an e-commerce webpage, an accounting interface, etc.) is typically developed and maintained independently of the RPA robot tasked with interacting with the respective interface. Consequently, the functionality and/or appearance of the target UI may change without the knowledge of RPA developers. Various UI elements may be moved around, renamed and/or resized, the color scheme of the UI may change, etc. Following such changes, the RPA robot may fail to identify the activity target, since it no longer has the expected characteristics.

Therefore, there is a strong interest in developing robust methods of identifying an RPA activity target, methods which are relatively insensitive to variations in the design of the target UI.

### SUMMARY OF THE INVENTION

According to one aspect, a computer system comprises at least one hardware processor configured to receive an encoding of a robotic process automation (RPA) activity and an encoding of a design-time target label, wherein the RPA activity mimics a human interaction with a target element of a user interface (UI), and wherein the design-time target label comprises a text label attached to the target element within a design-time instance of the UI. The at least one hardware processor is further configured to identify a runtime instance of the target element within a runtime instance of the UI exposed by the computer system and in response, to execute the RPA activity on the runtime instance of the target element. The runtime instance of the target element is identified according to a similarity between a meaning of the design-time target label and a meaning of a label attached to the runtime instance of the target element.

According to another aspect, a computer-implemented RPA method comprises employing at least one hardware processor of a computer system to receive an encoding of an RPA activity and an encoding of a design-time target label, wherein the RPA activity mimics a human interaction with a target element of a UI, and wherein the design-time target label comprises a text label attached to the target element within a design-time instance of the UI. The method further comprises employing the at least one hardware processor to identify a runtime instance of the target element within a runtime instance of the UI exposed by the computer system and in response, to execute the RPA activity on the runtime instance of the target element. The runtime instance of the target element is identified according to a similarity between a meaning of the design-time target label and a meaning of a label attached to the runtime instance of the target element.

According to yet another aspect, a non-transitory computer-readable medium stores instructions which, when executed by at least one hardware processor of a computer system, cause the computer system to receive an encoding of an RPA activity and an encoding of a design-time target label, wherein the RPA activity mimics a human interaction with a target element of a UI, and wherein the design-time target label comprises a text label attached to the target element within a design-time instance of the UI. The instructions further cause the computer system to identify a runtime instance of the target element within a runtime instance of the UI exposed by the computer system and in response, to execute the RPA activity on the runtime instance of the target element. The runtime instance of the target element is identified according to a similarity between a meaning of the design-time target label and a meaning of a label attached to the runtime instance of the target element.

### BRIEF DESCRIPTION OF DRAWINGS

The foregoing aspects and advantages of the present invention will become better understood upon reading the following detailed description and upon reference to the drawings where:

FIG. 1 shows an architectural diagram of a hyper-automation system according to some embodiments of the present invention.

FIG. 2 illustrates an exemplary RPA system according to some embodiments of the present invention.

FIG. 3 shows an exemplary deployed RPA system executing in a client-server configuration according to some embodiments of the present invention.

FIG. 4 shows an exemplary user interface (UI) and exemplary UI elements targeted by automations according to some embodiments of the present invention.

FIG. 5 shows exemplary design-time and runtime target user interfaces according to some embodiments of the present invention.

FIG. 6 shows an exemplary data exchange according to some embodiments of the present invention.

FIG. 7 shows an exemplary sequence of steps performed by an RPA design application according to some embodiments of the present invention.

FIG. 8 shows an exemplary RPA design interface according to some embodiments of the present invention.

FIG. 9 illustrates an exemplary semantic target selection interface exposed by the RPA design application according to some embodiments of the present invention.

FIG. 10 shows an exemplary sequence of steps performed by an RPA robot at runtime, according to some embodiments of the present invention.

FIG. 11 illustrates exemplary components of a label similarity query according to some embodiments of the present invention.

FIG. 12 shows an exemplary similarity indicator associated with a respective label similarity query according to some embodiments of the present invention.

FIG. 13 shows exemplary components of a semantic assessor module according to some embodiments of the present invention.

FIG. 14 illustrates the operation of an exemplary generative language model (GLM) according to some embodiments of the present invention.

FIG. 15 shows an exemplary structure of a GLM according to some embodiments of the present invention.

FIG. 16 shows an exemplary similarity measure d quantifying a semantic similarity between two character strings according to some embodiments of the present invention.

FIG. 17 shows an exemplary hardware configuration of a computer system programmed to execute some of the methods described herein.

### DETAILED DESCRIPTION OF THE INVENTION

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Any use of ‘or’ is meant as a nonexclusive or. Unless otherwise required, any described method steps need not be necessarily performed in a particular illustrated order. A first element (e.g., data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. The term ‘database’ is used herein to denote any organized, searchable collection of data. Semantic similarity herein denotes likeness of meaning, as opposed to likeness of wording. Stated otherwise, two text samples may be semantically similar even if they are phrased differently. Basic examples are synonyms and semantically-related words such as ‘car’ and ‘vehicle’. Conversely, two text samples may differ only slightly in wording, yet be semantically dissimilar (carry different meanings), as in the exemplary sentences ‘I will go through with the ceremony’ and ‘I will go through the ceremony plans’. Computer-readable media encompass non-transitory media such as magnetic, optic, and semiconductor storage media (e.g. hard drives, optical disks, flash memory, DRAM), as well as communication links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

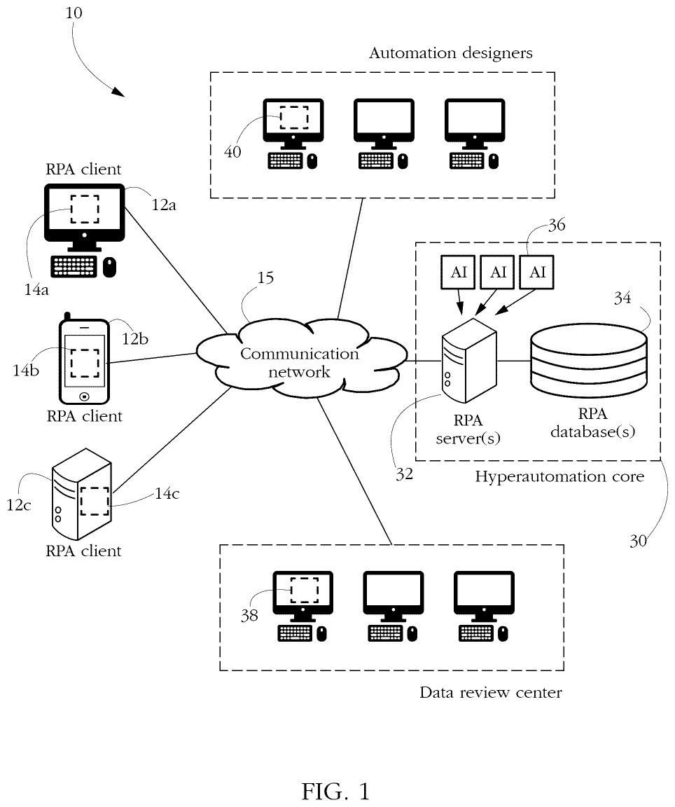

FIG. 1 is an architectural diagram illustrating a hyper-automation system 10 according to some embodiments of the present invention. ‘Hyper-automation’ as used herein refers to automation systems that bring together components of robotic process automation, integration tools, and technologies that amplify the ability to automate work. In an exemplary robotic process automation scenario, an employee of a company uses a business application (e.g., word processor, spreadsheet editor, browser, email application) to perform a repetitive task, for instance to issue invoices to various clients. To carry out the respective task, the employee performs a sequence of operations/actions, which is herein deemed a work process. Exemplary operations forming a part of an invoice-issuing work process may include opening a Microsoft Excel® spreadsheet, looking up company details of a client, copying the respective details into an invoice template, filling out invoice fields indicating the purchased items, switching over to an email application, composing an email message to the respective client, attaching the newly created invoice to the respective email message, and clicking a ‘Send’ button. Various elements of system 10 may collaborate to automate the respective work process by mimicking the set of operations performed by the respective human operator in the course of carrying out the respective task. Mimicking a human operation/action is herein understood to encompass reproducing the sequence of computing events that occur when a human operator performs the respective operation/action on the computer, as well as reproducing a result of the human operator's performing the respective operation on the computer. For instance, mimicking an action of clicking a button of a graphical user interface (GUI) may comprise having the operating system move the mouse pointer to the respective button and generating a mouse click event, or may alternatively comprise toggling the respective GUI button itself to a clicked state.

Exemplary processes targeted for RPA include processing of payments, invoicing, communicating with business clients (e.g., distribution of newsletters and/or product offerings), internal communication (e.g., memos, scheduling of meetings and/or tasks), auditing, and payroll processing, among others.

RPA may constitute the core of hyper-automation system 10, and in certain embodiments, automation capabilities may be expanded with artificial intelligence (AI)/machine learning (ML), process mining, analytics, and/or other advanced tools. As hyper-automation system 10 learns processes, trains AI/ML models, and employs analytics, for example, more and more knowledge work may be automated, and computing systems in an organization, e.g., both those used by individuals and those that run autonomously, may all be engaged to be participants in the hyper-automation process. Hyper-automation systems of some embodiments allow users and organizations to efficiently and effectively discover, understand, and scale automations.

Exemplary hyper-automation system 10 includes RPA client computing systems 12a-c, such as a desktop computer, server computer, and smart phone, among others. Any desired client computing system may be used without deviating from the scope of the invention including, but not limited to, smart watches, laptop computers, tablet computers, Internet-of-Things (IoT) devices, etc. Also, while FIG. 1 shows only three client computing systems 12a-c, any suitable number of client computing systems may be used without deviating from the scope of the invention. For instance, in some embodiments, dozens, hundreds, thousands, or millions of RPA clients may be used. RPA clients 12a-c may be actively operated by a user or run automatically without much or any user input.

Each illustrated RPA client computing system 12a-c has respective automation module(s) 14a-c running thereon. Exemplary automation module(s) 14a-c may include, but are not limited to, RPA robots, parts of an operating system, downloadable application(s) for the respective computing system, any other suitable software and/or hardware, or any combination of these without deviating from the scope of the invention.

In some embodiments, one or more of module(s) 14a-c may be listeners. Listeners monitor and record data pertaining to user interactions with respective computing systems and/or operations of unattended computing systems and send the data to a hyper-automation core system 30 via a communication network 15 (e.g., a local area network-LAN, a mobile communications network, a satellite communications network, the Internet, any combination thereof, etc.). The data may include, but is not limited to, which buttons were clicked, where a mouse was moved, the text that was entered in a field, that one window was minimized and another was opened, the application associated with a window, etc. In certain embodiments, the data from such listener processes may be sent periodically as part of a heartbeat message, or in response to a fulfillment of a data accumulation condition. One or more RPA servers 32 receive and store data from the listeners in a database, such as RPA database(s) 34 in FIG. 1.

Other exemplary automation module(s) 14a-c may execute the logic that actually implements the automation of a selected process. Stated otherwise, at least one automation module 14a-c may comprise a part of an RPA robot as further described below. Robots may be attended (i.e., requiring human intervention) or unattended. In some embodiments, multiple modules 14a-c or computing systems may participate in executing the logic of an automation. Some automations may orchestrate multiple modules 14a-c, may carry out various background processes and/or may perform Application Programming Interface (API) calls. Some robotic activities may cause a module 14a-c to wait for a selected task to be completed (possibly by another entity or automation module) before resuming the current workflow.

In some embodiments, hyper-automation core system 30 may run a conductor application on one or more server computer systems, such as RPA server(s) 32. While FIG. 1 shows only one RPA server 32, multiple or many servers that are proximate to one another or in a distributed architecture may be employed without deviating from the scope of the invention. For instance, one or more of RPA server(s) 32 may be provided for conductor functionality, AI/ML model serving, authentication, governance, and or any other suitable functionality without deviating from the scope of the invention. In some embodiments, hyper-automation core system 30 may incorporate or be part of a public cloud architecture, a private cloud architecture, a hybrid cloud architecture, etc. In certain embodiments, hyper-automation core system 30 may host multiple software-based servers on one or more computing systems, such as RPA server(s) 32. In some embodiments, one or more servers of core hyper-automation system 30, such as RPA server(s) 32, may be implemented via one or more virtual machines (VMs).

In some embodiments, one or more of automation modules 14a-c may call one or more AI/ML models 36 deployed on or accessible by hyper-automation core 30. AI/ML models 36 may be trained for any suitable purpose without deviating from the scope of the invention. Two or more of AI/ML models 36 may be chained in some embodiments (e.g., in series, in parallel, or a combination thereof) such that they collectively provide collaborative output(s). Exemplary AI/ML models 36 may perform or assist with computer vision (CV), image processing, segmentation, and recognition, optical character recognition (OCR), document processing and/or understanding, semantic learning and/or analysis, analytical predictions, process discovery, task mining, testing, automatic RPA workflow generation, sequence extraction, clustering detection, audio-to-text translation, any combination thereof, etc. However, any desired number and/or type(s) of AI/ML models 36 may be used without deviating from the scope of the invention. Using multiple AI/ML models 36 may allow the system to develop a global picture of what is happening on a given computing system, for example. For instance, one AI/ML model could perform OCR, another could detect buttons, another could compare sequences, etc. Patterns may be determined individually by an AI/ML model or collectively by multiple AI/ML models. In certain embodiments, one or more AI/ML models 36 are deployed locally on at least one of RPA client computing systems 12a-c.

Hyper-automation system 10 may provide at least four main groups of functionality: (1) discovery; (2) building automations; (3) management; and (4) engagement. The discovery functionality may discover and provide automatic recommendations for different opportunities of automations of business processes. Such functionality may be implemented by one or more servers, such as RPA server 32. The discovery functionality may include providing an automation hub, process mining, task mining, and/or task capture in some embodiments.

The automation hub (e.g., UiPath Automation Hub™) may provide a mechanism for managing automation rollout with visibility and control. Automation ideas may be crowdsourced from employees via a submission form, for example. Feasibility and return on investment (ROI) calculations for automating these ideas may be provided, documentation for future automations may be collected, and collaboration may be provided to get from automation discovery to build-out faster.

Process mining (e.g., via UiPath Automation Cloud™ and/or UiPath AI Center™) refers to the process of gathering and analyzing the data from applications (e.g., enterprise resource planning (ERP) applications, customer relation management (CRM) applications, email applications, call center applications, etc.) to identify what end-to-end processes exist in an organization and how to automate them effectively, as well as indicate what the impact of the automation will be. This data may be gleaned from RPA clients 12a-c by listeners, for example, and processed by RPA server(s) 32. One or more AI/ML models 36 may be employed for this purpose. This information may be exported to the automation hub to speed up implementation and avoid manual information transfer. The goal of process mining may be to increase business value by automating processes within an organization. Some examples of process mining goals include, but are not limited to, increasing profit, improving customer satisfaction, regulatory and/or contractual compliance, improving employee efficiency, etc.

Task mining (e.g., via UiPath Automation Cloud™ and/or UiPath AI Center™) identifies and aggregates workflows (e.g., employee workflows), and then applies AI to expose patterns and variations in day-to-day tasks, scoring such tasks for ease of automation and potential savings (e.g., time and/or cost savings). One or more AI/ML models 36 may be employed to uncover recurring task patterns in the data. Repetitive tasks that are ripe for automation may then be identified. This information may initially be provided by listener modules (e.g., automation modules 14a-c) and analyzed on servers of hyper-automation core 30. The findings from task mining process may be exported to process documents or to an RPA design application such as UiPath Studio™ to create and deploy automations more rapidly.

Task mining in some embodiments may include taking screenshots with user actions (e.g., mouse click locations, keyboard inputs, application windows and graphical elements the user was interacting with, timestamps for the interactions, etc.), collecting statistical data (e.g., execution time, number of actions, text entries, etc.), editing and annotating screenshots, specifying types of actions to be recorded, etc.

Task capture (e.g., via UiPath Automation Cloud™ and/or UiPath AI Center™) automatically documents attended processes as users work or provides a framework for unattended processes. Such documentation may include desired tasks to automate in the form of process definition documents (PDDs), skeletal workflows, capturing actions for each part of a process, recording user actions and automatically generating a comprehensive workflow diagram including the details about each step, Microsoft Word® documents, XAML files, and the like. Build-ready workflows may be exported directly to an RPA design application, such as UiPath Studio™. Task capture may simplify the requirements gathering process for both subject matter experts explaining a process and Center of Excellence (CoE) members providing production-grade automations.

The automation building functionality of hyper-automation system 10 may be accomplished via a computer program, illustrated as an RPA design application 40 in FIG. 1. Examples include UiPath Studio™, UiPath StudioX™, or UiPath Web™, among others. Such computer programs may be used to build and test automations for various applications and environments, such as web, mobile, SAP®, and virtualized desktops. In some embodiments, RPA design application 40 enables a human developer to design a workflow that effectively automates a target work process. A workflow typically comprises a sequence of custom automation steps, herein deemed RPA activities. Each activity includes at least one action performed by the robot, such as clicking a button, reading a file, writing to a spreadsheet cell, etc. Activities may be nested and/or embedded. In some embodiments, RPA design application 40 exposes a design interface and set of tools that give the developer control of the execution order and the relationship between activities of a workflow. In some embodiments, predefined activities, drag-and-drop modeling, and a workflow recorder may make automation easier with minimal coding. Document understanding functionality may be provided by AI activities for data extraction and interpretation that call one or more AI/ML models 36. Such automations may process virtually any document type and format, including tables, webpages, forms, signatures, and handwriting.

RPA design application 40 may also be used to seamlessly combine user interface (UI) automation with API automation, for example to provide API integration with various other applications, technologies, and platforms. A repository (e.g., UiPath Object Repository™) or marketplace (e.g., UiPath Marketplace™) for pre-built RPA and AI templates and solutions may be provided to allow developers to automate a wide variety of processes more quickly. Thus, when building automations, hyper-automation system 10 may provide user interfaces, development environments, API integration, pre-built and/or custom-built AI/ML models, development templates, integrated development environments (IDEs), and advanced AI capabilities. Hyper-automation system 10 may further enable deployment, management, configuration, monitoring, debugging, and maintenance of RPA robots for carrying out the automations designed using application 40.

The management functionality of hyper-automation system 10 may provide deployment, orchestration, test management, AI functionality, and optimization of automations across an organization. Other exemplary aspects of management functionality include DevOps activities such as continuous integration and continuous deployment of automations. Management functionality may also act as an integration point with third-party solutions and applications for automation applications and/or RPA robots.

As an example of management functionality, a conductor application or service may facilitate provisioning, deployment, configuration, queuing, monitoring, logging, and interconnectivity of RPA robots, among others. Examples of such conductor applications/services include UiPath Orchestrator™ (which may be provided as part of the UiPath Automation Cloud™ or on premises, inside a virtual machine, or as a cloud-native single container suite via UiPath Automation Suite™). A test suite of applications/services (e.g., UiPath Test Suite™) may further provide test management to monitor the quality of deployed automations. The test suite may facilitate test planning and execution, meeting of requirements, and defect traceability. The test suite may include comprehensive test reporting.

Analytics software (e.g., UiPath Insights™) may track, measure, and manage the performance of deployed automations. The analytics software may align automation operations with specific key performance indicators (KPIs) and strategic outcomes for an organization. The analytics software may present results in a dashboard format for better understanding by human users.

AI management functionality may be provided by an AI center (e.g., UiPath AI Center™), which facilitates incorporation of AI/ML models into automations. Pre-built AI/ML models, model templates, and various deployment options may make such functionality accessible even to those who are not data scientists. Deployed automations (e.g., RPA robots) may call AI/ML models 36 from the AI center. Performance of the AI/ML models may be monitored. Models 36 may be trained and improved using human-validated data, such as that provided by a data review center as illustrated in FIG. 1. Human reviewers may provide labeled data (e.g., a training corpus) to hyper-automation core 30 via a review application 38 executing on a computer connected to network 15. Reviewers may also use application 38 to validate that predictions by AI/ML models 36 are accurate, and provide corrections otherwise. This dynamic input may then be saved as training data for retraining AI/ML models 36, and may be stored in a database such as RPA database 34, for example. The AI center may schedule and execute training jobs to train the new versions of AI/ML models 36 using the training data.

The engagement functionality of hyper-automation system 10 engages humans and automations as one team for seamless collaboration on desired processes. Low-code applications may be built (e.g., via UiPath Apps™) to connect to browser and legacy software. Applications may be created quickly using a web browser through a rich library of drag-and-drop controls, for instance. An application can be connected to a single automation or multiple automations. An action center (e.g., UiPath Action Center™) may provide a mechanism to hand off processes from robots to humans, and vice versa. Humans may provide approvals or escalations, make exceptions, etc. RPA robots may then perform the automatic functionality of a given workflow.

A local assistant may be provided as a launchpad for users to launch automations (e.g., UiPath Assistant™). This functionality may be provided in a tray provided by an operating system, for example, and may allow users to interact with RPA robots and RPA robot-powered applications on their computing systems. An interface may list automations/workflows approved for a given user and allow the user to run them. These may include ready-to-go automations from an automation marketplace, an internal automation store in an automation hub, etc. When automations run, they may run as a local instance in parallel with other processes on the computing system so users can use the computing system while the automation performs its actions. In certain embodiments, the assistant is integrated with the task capture functionality such that users can document their soon-to-be-automated processes from the assistant launchpad.

In another exemplary engagement functionality, Chatbots (e.g., UiPath Chatbots™), social messaging applications, an/or voice commands may enable users to run automations. This may simplify access to information, tools, and resources users need to interact with customers or perform other activities. For instance, a chatbot may respond to a command formulated in a natural language by triggering a robot configured to perform operations such as checking an order status, posting data in a CRM, etc.

In some embodiments, some functionality of hyper-automation system 10 may be provided iteratively and/or recursively. Processes can be discovered, automations can be built, tested, and deployed, performance may be measured, use of the automations may readily be provided to users, feedback may be obtained, AI/ML models may be trained and retrained, and the process may repeat itself. This facilitates a more robust and effective suite of automations.

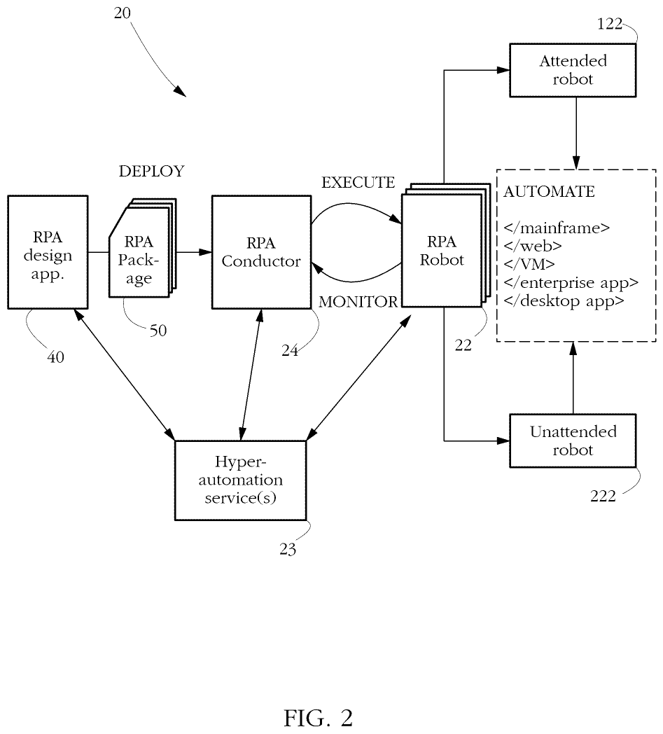

FIG. 2 illustrates exemplary components and operation of an RPA system 20 according to some embodiments of the present invention. RPA system 20 may form a part of hyper-automation system 10 of FIG. 1. RPA system 20 includes an RPA design application 40 that enables a developer to build automations, i.e., design and implement RPA workflows. For instance, application 40 may expose a user interface and set of tools that give the developer control of the execution order and the relationship between activities of a workflow. One commercial example of RPA design application 40 is UiPath Studio™

Some types of RPA workflows may include, but are not limited to, sequences, flowcharts, finite state machines (FSMs), and/or global exception handlers. Sequences may be particularly suitable for linear processes, enabling flow from one activity to another without cluttering a workflow. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

Once a workflow is developed, it may be encoded in computer-readable form, such as an RPA script or an RPA package 50 (FIG. 2). An RPA script comprises a specification of the respective workflow, the specification comprehensible to (or interpretable by) RPA robot 22. RPA scripts may be formulated according to any data specification format known in the art, for instance in a version of an extensible markup language (XML), Javascript Object Notation (JSON), or a programming language such as C#, Visual Basic, Java, etc. Alternatively, RPA scripts may be formulated in an RPA-specific version of bytecode, or even as a sequence of instructions formulated in a natural language such as English, Spanish, Japanese, etc. In some embodiments, one or more related RPA scripts are bundled together with other files and/or metadata, to form RPA package 50. For instance, beside RPA scripts, RPA package 50 may comprise a specification of a resource required for executing the respective workflow(s). Exemplary resources include a location of a file (e.g., path, URL), a filename, and a set of credentials for accessing a particular machine, computer program, or service, among others. In what is commonly known in the art as a ‘build’, RPA scripts may be pre-compiled into a set of executable files which may include a main executable and accompanying libraries, resource specifications and metadata, to form RPA package 50. Package 50 may use any data specification format known in the art. For instance, some embodiments of package 50 comprise a NuGet package of .NET assembly files.

A skilled artisan will appreciate that RPA design application 40 may comprise multiple components/modules, which may execute on distinct physical machines. In one such example illustrating a cloud computing embodiment of the present invention, RPA design application 40 may execute in a client-server configuration, wherein one component of application 40 may expose an automation design interface on the developer's computer, and another component of application 40 executing on a remote server may assemble the workflow and formulate/output RPA package 50. For instance, a developer may access the automation design interface via a web browser executing on the developer's computer, while the software processing the user input received at the developer's computer actually executes on the server.

In some embodiments, a workflow designed in RPA design application 40 is deployed to an RPA conductor 24, for instance in the form of an RPA package as described above. Per the above, in some embodiments, conductor 24 may be part of hyper-automation core system 30 illustrated in FIG. 1. One commercial example of conductor 24 is UiPath Orchestrator™.

Conductor 24 orchestrates one or more RPA robots 22 that execute the respective workflow. Such ‘orchestration’ may include creating, monitoring, and deploying computing resources for robots 22 in an environment such as a cloud computing system and/or a local computer. Orchestration may further comprise, among others, deployment, configuration, queueing, monitoring, logging of robots 22, and/or providing interconnectivity for robots 22. Provisioning may include creating and maintaining connections between robots 22 and conductor 24. Deployment may include ensuring the correct delivery of software (e.g, RPA packages 50, individual workflow specifications) to robots 22 for execution. Configuration may include maintenance and delivery of robot environments and workflow configurations. Queueing may include providing management of job queues and queue items. Monitoring may include keeping track of robot state and maintaining user permissions. Logging may include storing and indexing logs to a database and/or another storage mechanism (e.g., SQL, ElasticSearch®, Redis®). Conductor 24 may further act as a centralized point of communication for third-party solutions and/or applications. In some embodiments as further described below, conductor 24 may further provide automation troubleshooting services and assistance.

RPA robots 22 are execution agents (e.g., computer programs) that implement automation workflows targeting various systems and applications including, but not limited to, mainframes, web applications, virtual machines, enterprise applications (e.g., those produced by SAP®, SalesForce®, Oracle®, etc.), desktop and laptop applications, mobile device applications, wearable computer applications, etc. One commercial example of robot 22 is UiPath Robots™.

In some embodiments, to mimic a human user's interaction with a user interface of a target application, RPA robot 22 interfaces with a set of RPA drivers 25 executing on the respective RPA client/host computer. Such drivers generically represent software modules that carry low-level operations such as moving a cursor on screen, registering and/or executing mouse, keyboard, and/or touchscreen events, detecting a current posture/orientation of a handheld device, detecting a current accelerometer reading, taking a photograph with a smartphone camera, grabbing a screenshot of the respective device, etc. Some such drivers form a part of the local operating system. Other RPA drivers 25 may implement various application-specific aspects of a user's interaction with complex target applications such as SAP®, Citrix® virtualization software, Microsoft Excel®, etc. One particular example comprises a browser driver, which may be embodied as a set of browser-compatible scripts (e.g. JavaScript®). When injected into a web page currently displayed within the browser, such a browser driver may identify various elements of the respective web page (e.g., buttons, menus, form fields, etc.), and may invoke a specific functionality of a respective element (e.g., type into a form field, select a menu item, toggle a checkbox, etc.). Other exemplary RPA drivers 25 include the Microsoft® WinAppDriver, XCTest drivers from Apple, Inc., and UI Automator drivers from Google, Inc.

Types of robots may include attended robots 122, unattended robots 222, development robots (similar to unattended robots, but used for development and testing purposes), and nonproduction robots (similar to attended robots, but used for development and testing purposes), among others. Some activities of attended robots 122 are triggered by user events and/or commands and operate alongside a human operator on the same computing system. In some embodiments, attended robots 122 can only be started from a robot tray or from a command prompt and thus cannot be entirely controlled by conductor 24 and cannot run under a locked screen, for example. Unattended robots may run unattended in remote virtual environments and may be responsible for remote execution, monitoring, scheduling, and providing support for work queues.

In some embodiments executing in a Windows® environment, robot 22 installs a Microsoft Windows® Service Control Manager (SCM)-managed service by default. As a result, such robots can open interactive Windows® sessions under the local system account and have the processor privilege of a Windows® service. For instance, a console application may be launched by a SCM-managed robot. In some embodiments, robot 22 may be installed at a user level of processor privilege (user mode, ring 3.) Such a robot has the same rights as the user under which the respective robot has been installed. For instance, such a robot may launch any application that the respective user can. On computing systems that support multiple interactive sessions running simultaneously (e.g., Windows® Server 2012), multiple robots may be running at the same time, each in a separate Windows® session, using different usernames.

In some embodiments, robots 22 are split into several components, each being dedicated to a particular automation task. The robot components in some embodiments include, but are not limited to, SCM-managed robot services, user-mode robot services, executors, agents, and command-line. Depending on platform details, SCM-managed and/or user-mode robot services manage and monitor Windows® sessions and act as a proxy between conductor 24 and the host machines (i.e., the computing systems on which robots 22 execute). These services are trusted with and manage the credentials for robots 22. The command line is a client of the service(s), a console application that can be used to launch jobs and display or otherwise process their output.

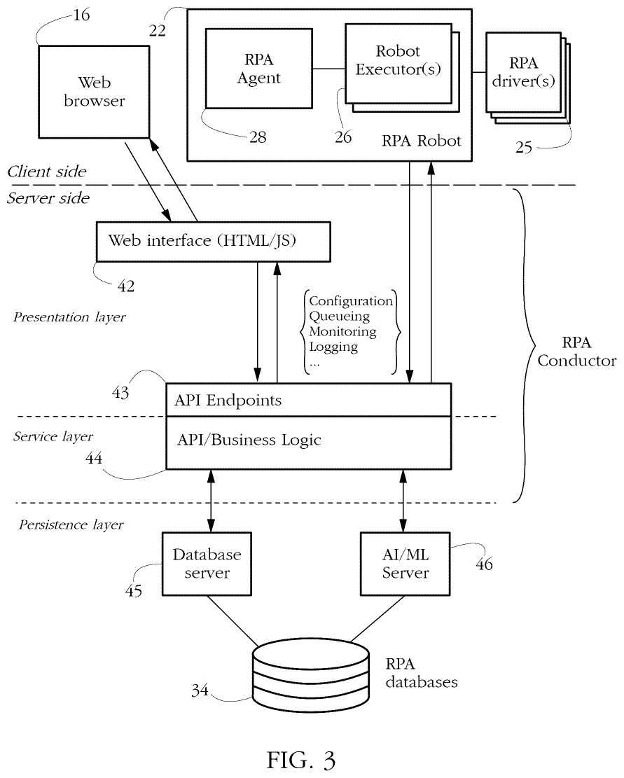

An exemplary set of robot executors 26 and an RPA agent 28 are illustrated in FIG. 3. Robot executors 26 may run given jobs under a Windows® session. Executors 26 are configured to receive RPA package 50 specifying a workflow (e.g., sequence of robotic activities), and to execute the respective package which effectively amounts to carrying out the respective sequence of RPA activities. In some embodiments, package 50 comprises pre-compiled executable code. In other exemplary embodiments, robot executor(s) 26 comprise an interpreter (e.g., a just-in-time interpreter or compiler) configured to translate a received RPA script comprising a workflow specification (e.g., bytecode, XML, JSON etc.) into runtime code comprising processor instructions for carrying out the respective workflow. Executing RPA package 50 may thus comprise executor(s) 26 translating a workflow specification included in package 50 and instructing a processor of the respective host machine to load the resulting runtime code into memory and to launch the runtime code into execution.

RPA agent 28 may manage the operation of robot executor(s) 26. For instance, RPA agent 28 may select tasks/scripts for execution by robot executor(s) 26 according to an input from a human operator and/or according to a schedule. Agent 28 may start and stop jobs and configure various operational parameters of executor(s) 22. When robot 22 includes multiple executors 26, agent 28 may coordinate their activities and/or inter-process communication. RPA agent 28 may further manage communication between RPA robot 22 and conductor 24 and/or other entities.

Exemplary RPA system 20 in FIG. 2 forms a part of hyper-automation system 10 (see FIG. 1). As such, robots 22 may interact with various components and use various aspects of hyper-automation core system 30, illustrated generically as hyper-automation services 23 in FIG. 2. For instance, developers may use RPA design application 40 to build and test RPA robots 22 that utilize AI/ML models 36. Such RPA robots 22 may send input for execution of the AI/ML model(s) and receive output therefrom via hyper-automation core system 30. Robot 22 may be a listener, as described above. These listeners may provide information to core hyper-automation system 30 regarding what users are doing when they use their computing systems. This information may then be used by hyper-automation system 30 for process mining, task mining, task capture, etc. In another exemplary embodiment, hyper-automation services 23 may expose data labeling functionality to user of the computing system hosting robot 22 or to another computing system that robot 22 provides information to. For instance, if robot 22 calls a computer vision AI/ML model 36 but the respective model does not correctly identify a button on the screen, the user may explicitly provide a correct identification. Such information may be passed on to hyper-automation core system 30 and then used for re-training the respective AI/ML model.

In some embodiments, selected components of hyper-automation system 10 and/or RPA system 20 may execute in a client-server configuration. In one such configuration illustrated in FIG. 3, RPA robot 20 including executor(s) 26 and RPA agent 28 may execute on a client side, for instance on one of RPA client computers 12a-c in FIG. 1. In turn, the functionality of conductor 24 and/or other services of hyper-automation core system 30 may be implemented on the server side, e.g., on remote RPA servers 32 (FIG. 1). It should be noted that the client side, the server side, or both, may include any desired number of computing systems (e.g., physical or virtual machines) without deviating from the scope of the invention. The illustrated RPA system may be cloud-based, on-premises, or a combination thereof, offering enterprise-level, user-level, or device-level automation solutions for automation of different work processes.

Robot 22 may run several jobs/workflows concurrently. RPA agent 28 (e.g., a Windows® service) may act as a single client-side point of contact of multiple executors 26. Agent 28 may further manage communication between robot 22 and conductor 24. In some embodiments, communication is initiated by RPA agent 28, which may open a WebSocket channel to conductor 24. Agent 28 may subsequently use the channel to transmit notifications regarding the state of each executor 26 to conductor 24, for instance as a heartbeat signal. In turn, conductor 24 may use the channel to transmit acknowledgements, job requests, and other data such as RPA packages 50 to robot 22.

In one embodiment as illustrated in FIG. 3, conductor 24 includes a web interface 42 and a set of service modules comprising a set of Application Programming Interface (API) endpoints 43 and service APIs/business logic 44. A user may interact with conductor 24 via web interface 42 (e.g., by opening a dedicated web page on a browser 16), to instruct conductor 24 to carry out actions such as scheduling and/or starting jobs on robot 22, creating robot groups/pools, assigning workflows to robots, adding/removing data to/from queues, analyzing logs per robot or workflow, etc. Interface 42 may be implemented using Hypertext Markup Language (HTML), JavaScript (JS), or any other data format known in the art.

Conductor 24 may carry out actions requested by the user by selectively calling service APIs/business logic 44 via endpoints 43. In addition, some embodiments use API endpoints 43 to communicate between RPA robot 22 and conductor 24, for tasks such as configuration, logging, deployment, monitoring, and queueing, among others. API endpoints 43 may be set up using any data format and/or communication protocol known in the art. For instance, API endpoints 43 may be Representational State Transfer (REST) and/or Open Data Protocol (OData) compliant.

Configuration endpoints may be used to define and configure application users, permissions, robots, assets, releases, etc. Logging endpoints may be used to log different information, such as errors, explicit messages sent by robot 22, and other environment-specific information. Deployment endpoints may be used by robot 22 to query the version of RPA package 50 to be executed. Queueing endpoints may be responsible for queues and queue item management, such as adding data to a queue, obtaining a transaction from the queue, setting the status of a transaction, etc. Monitoring endpoints may monitor the execution of web interface 42 and/or RPA agent 28.

Service APIs 44 comprise computer programs accessed/called through configuration of an appropriate API access path, e.g., based on whether conductor 24 and an overall hyper-automation system have an on-premises deployment type or a cloud-based deployment type. Exemplary APIs 44 provide custom methods for querying stats about various entities registered with conductor 24. Each logical resource may be an OData entity in some embodiments. In such an entity, components such as a robot, process, queue, etc., may have properties, relationships, and operations. APIs 44 may be consumed by web application 42 and/or RPA agent 28 by getting the appropriate API access information from conductor 24, or by registering an external application to use the OAuth flow mechanism.

In some embodiments, a persistence layer of server-side operations implements a database service. A database server 45 may be configured to selectively store and/or retrieve data to/from RPA databases 34. Database server 45 and database 34 may employ any data storage protocol and format known in the art, such as structured query language (SQL), ElasticSearch®, and Redis®, among others. Exemplary data stored/retrieved by server 45 may include configuration parameters of robots 22 and robot pools, as well as data characterizing workflows executed by robots 22, data characterizing users, roles, schedules, queues, etc. In some embodiments, such information is managed via web interface 42. Another exemplary category of data stored and/or retrieved by database server 45 includes data characterizing the current state of each executing robot, as well as messages logged by robots during execution. Such data may be transmitted by robots 22 via API endpoints 43 and centrally managed by conductor 24, for instance via API logic 44.

Server 45 and database 34 also store/manage process mining, task mining, and/or task capture-related data, for instance received from listener modules executing on the client side as described above. In one such example, listeners may record user actions performed on their local hosts (e.g., clicks, typed characters, locations, applications, active elements, times, etc.) and then convert these into a suitable format to be provided to and stored in database 34.

In some embodiments, a dedicated AI/ML server 46 facilitates incorporation of AI/ML models 36 into automations. Pre-built AI/ML models, model templates, and various deployment options may make such functionality accessible even to operators who lack advanced or specialized AI/ML knowledge. Deployed robots 22 may call AI/ML models 36 by interfacing with AI/ML server 46. Performance of the deployed AI/ML models 36 may be monitored and the respective models may be re-trained and improved using human-validated data. AI/ML server 46 may schedule and execute training jobs and manage training corpora. AI/ML server 46 may further manage data pertaining to AI/ML models 36, document understanding technologies and frameworks, algorithms and software packages for various AI/ML capabilities including, but not limited to, intent analysis, natural language processing (NLP), speech analysis and synthesis, computer vision (image processing, segmentation, and recognition), etc.

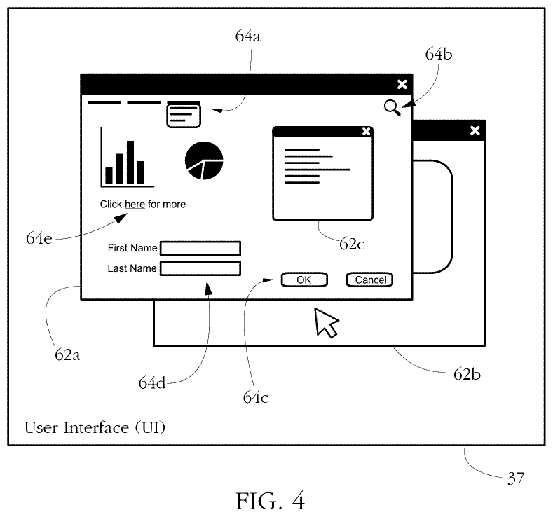

Embodiments of the present invention are directed at automating interactions with user interfaces. FIG. 4 illustrates an exemplary user interface 37 according to some embodiments of the present invention. In general, a user interface (UI) is a computer interface that enables human-machine interaction, e.g., an interface configured to receive user input, respond to the respective input, and communicate results of a computation back to the user. User interfaces frequently include a visual representation of a target document (e.g., an HTML document, a form, a spreadsheet, etc.) and a set of UI control elements enabling the user to manipulate or otherwise interact with the respective target document. A common example of user interface is known as a graphical user interface (GUI), which enables human-machine interaction via a set of graphical UI elements displayed to the user. Exemplary UI elements illustrated in FIG. 4 include a window 62a-c, a menu 64a, an icon 64b, a button 64c, an input field 64d, and a hyperlinked text 64e (also known as a link label or anchor text). Other exemplary UI elements comprise, among others, a label, a text area, a form having multiple input fields, and a toggle. Some UI elements may be nested within other UI elements. For instance, a menu may have multiple menu items and/or submenus, a form may have multiple input fields of various types, etc. UI elements may play various functional roles, such as containers for displaying information, input controls, navigational controls, etc.

In typical UI automations, an RPA robot is configured to emulate a human user's interaction with various elements of a target UI, for instance the user's clicking on button 64c or filling out input field 64d of target UI 37. RPA typically comprises two distinct stages. In a first stage denoted herein as design-time, an RPA designer configures the RPA robot to carry out the desired automation. Designing the respective automation may include indicating a set of RPA activities to carry out, and providing data enabling the robot to correctly identify the target of each such activity, i.e., the correct input field to fill in, the correct button to click, etc. Target identification is typically done according to a set of attributes characteristic of the respective target. Target characteristics may be programmatic (i.e., extracted from or determined according to a source code and/or an internal computer representation of the target document, such as a UI tree or DOM) and/or visual (e.g., on-screen position, image, color, label, etc.). Once determined, the target characteristics may be included in the workflow specification. In a subsequent stage of automation commonly referred to as runtime, the RPA robot effectively executes the respective workflow, i.e., carries out the RPA activities as specified in the workflow specification. To achieve this, the robot must correctly identify the activity targets within the target UI and act on them.

Crucially, the target UI used at design time (herein deemed design-time UI) is typically not the same as the target UI used at runtime (herein deemed runtime UI), since the design and execution of the respective workflow may be separated in space and time. Instead, the design-time UI and runtime UI are merely instances of the same target UI, the respective target UI defined by an identity of a target document rendered by the respective target UI. Stated otherwise, both the design-time UI and the runtime UI display a document/resource having the same identifier (e.g., document name, universal resource identifier-URI, location such as a universal resource locator-URL, etc.). However, sometimes the content and/or layout of the target document unexpectedly changes between design-time and runtime, since the target document is maintained independently of the automation itself. Following such changes, the design-time and runtime instances of the target UI may differ. For instance, some target-identification data of various UI elements may change, causing the automation to fail.

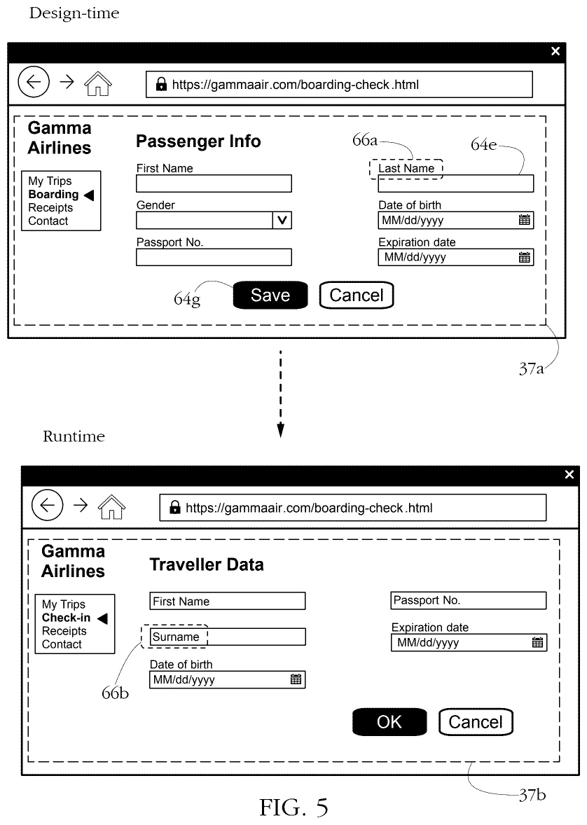

In one such exemplary use-case scenario illustrated in FIG. 5, an RPA robot is tasked with automatically filling out a web-based airport check-in form (i.e., the target document, herein comprising an HTML form with the illustrated URL) with passenger data. At design time, the automation designer designs an RPA workflow that includes activities for interacting with a design-time instance of the target UI, herein an exemplary design-time UI 37a. For instance, an RPA activity of the workflow may comprise filling in target input field 64e, while another RPA activity of the workflow may comprise clicking on button 64g.

FIG. 5b further shows an exemplary runtime UI 37b encountered by RPA robot 22 at runtime. While being an instance of the same the same web form used to design the respective automation (as indicated for instance by the same URL), runtime UI 37b differs slightly from design-time UI 37a. Exemplary changes include changes in the relative positions of some input fields, some menu items, as well as the positioning and/or content of some input field labels. Furthermore, the type of visual elements used to label input fields have changed, e.g., from simple text in UI 37a to default input/placeholder values in UI 37b. Such changes may cause an automation to fail because the RPA robot may no longer correctly identify activity targets. In the example illustrated in FIG. 5, the robot may be configured to fill in input field 64e but may be unable to find an input field with the respective characteristics within runtime UI 37b. Similarly, a robot configured to click on button 64g may fail to find such a button with the runtime UI. Some embodiments of the present invention directly address such shortcomings.

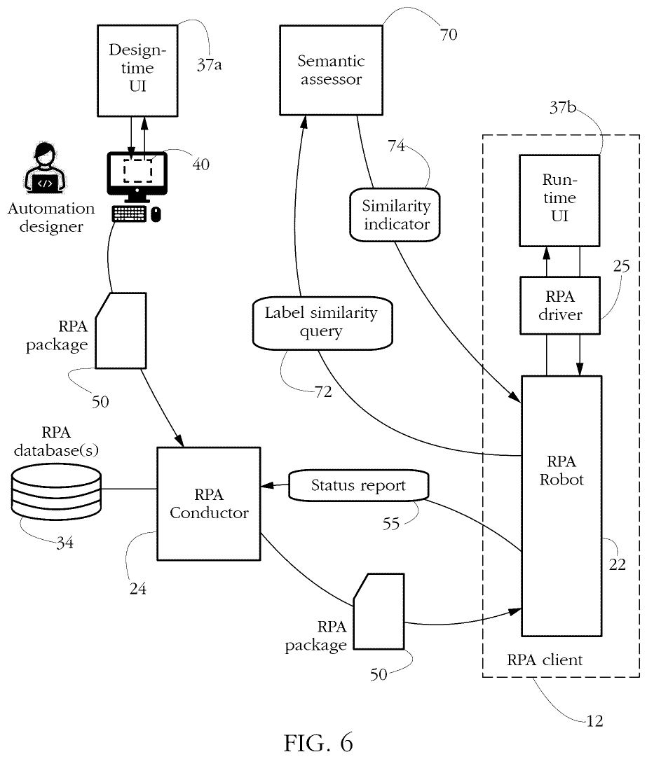

FIG. 6 shows an exemplary data exchange according to some embodiments of the present invention. At design time, an automation designer uses an instance of RPA design application 40 to design an automation workflow. Application 40 may interact with a design-time instance of a target UI, i.e., design-time UI 37a. An RPA package 50 including a specification of the respective workflow is then delivered to RPA conductor 24 for further distribution to an RPA client 12, which generically represents any of RPA clients 12a-c in FIG. 1. In the airport check-in automation example above, RPA client 12 may comprise a desktop computer located at an airport terminal, or a cloud computing platform operated by the respective airline. RPA client 12 executes an instance of RPA robot 22, which interacts with a runtime instance of the target UI (runtime UI 37b) via local instance of RPA driver(s) 25 and transmits status reports 55 on the progress of the respective automation to RPA conductor 24. In some embodiments of the present invention, RPA robot 22 and/or driver(s) 25 may collaborate with a semantic assessor module 70 to correctly identify activity targets as shown in detail below. A skilled artisan will know that the system illustrated in FIG. 6 is only exemplary and can be modified without altering the scope of the present invention. For instance, in alternative embodiments, the respective automation may execute locally, i.e., on the computer that also executes RPA design application 40 and without involvement of RPA conductor 24.

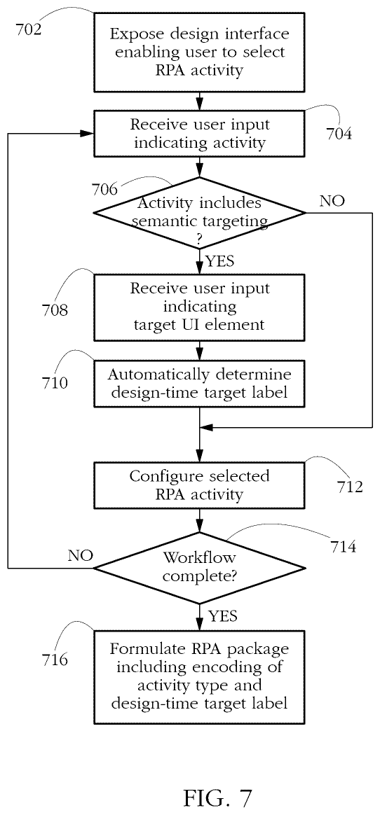

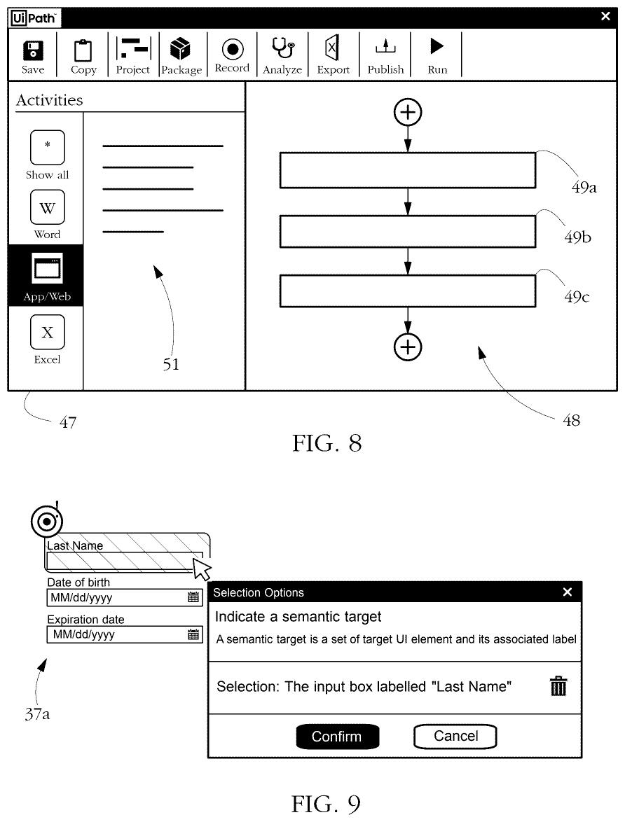

FIG. 7 shows an exemplary sequence of steps performed by RPA design application 40 to design an automation workflow directed at interacting with a target UI according to some embodiments of the present invention. A step 702 exposes a robot design interface to the user/automation designer. An exemplary robot design interface 47 is illustrated in FIG. 8 and draws a visual representation of an RPA workflow 48 as a sequence of RPA activities. An artisan will understand that the content and appearance of interface 47 are only exemplary and not meant to be limiting. In the illustrated example, each RPA activity or group of activities of the workflow is represented by an individual activity container 49a-c, each such container optionally displaying an activity configuration interface for configuring various parameters of the respective RPA activity. Containers 49a-c may comprise children windows of interface 47. In some embodiments, containers 49a-c may be nested, i.e., some containers may further include a hierarchy of sub-containers representing individual RPA activities, etc. Robot design interface 47 may further expose various controls enabling the user to add, delete, and re-arrange activities of workflow 48.

In some embodiments as illustrated, robot design interface 47 further displays an activity menu 51 listing or otherwise enabling the user to select RPA activities for inclusion into workflow 48. Activities may be grouped according to various criteria, for instance, according to a type of user interaction (e.g., clicking, tapping, gestures, hotkeys), according to a type of data (e.g., text-related activities, image-related activities), according to a type of data processing (e.g., navigation, data scraping, form filling), according to a type of target application (e.g., browser, spreadsheet, word processing), etc. In some embodiments, individual RPA activities may be reached via a hierarchy of submenus.

In a step 704, RPA design application 40 may receive a user input selecting an RPA activity for inclusion into workflow 48. Step 704 may further include re-drawing workflow 48 to include the newly selected RPA activity, e.g., adding an activity container and positioning it as desired within workflow 48.

Some RPA activities invoked via activity menu 51 may include semantic targeting, which herein denotes identifying the target of the respective activity according to semantic criteria such as a meaning of a label attached to a target UI element as described below. Some embodiments may allow the user to select between activities that use semantic targeting and activities that do not. For instance, menu 51 may include a form-filling activity that identifies a target input field by conventional means (e.g., via programmatic attributes such as a set of attribute-value pairs characterizing the respective UI element and determined according to a DOM) and another form-filling activity that uses semantic targeting to identify the respective input field. The user may thus have a choice between the two, based on the observation that each activity may be better suited to a distinct type of target UI.

A step 706 may determine whether the selected RPA activity comprises semantic targeting. When NO, some embodiments may proceed with activity-specific configuration actions which go beyond the scope of the present description. When the selected activity includes semantic targeting (step 704 returns a YES), in a step 708 application 40 may receive a user input indicating a target UI element, herein denoting a UI element of UI 37a targeted by the respective RPA, e.g., a button to be clicked, an input field to be filled-in, etc. In some embodiments, the target-selecting user input comprises the user's hovering over, clicking, or tapping the desired element within the UI 37a. Some embodiments may further display a semantic target selection interface to the user, for instance as an overlay. An exemplary semantic target selection interface as described herein is illustrated in FIG. 9, wherein the target element selected by the user (an input field of UI 37a in the shown example) is highlighted for clarity. The target selection interface may further enable the user to confirm or cancel a selected target element.

In a step 710, some embodiments may determine a design-time target label, herein denoting a text label/character string displayed within design-time UI 37a in a vicinity of the selected target element. Exemplary target labels illustrated in FIG. 5 include label 66a associated with target input field 64a and the label ‘Save’ displayed on target button 64g. Determining the design-time target label may comprise using RPA driver(s) 25 to analyze UI 37a (e.g., a DOM in the case of a web page as illustrated in FIG. 5) to identify candidate labels. Exemplary candidate labels include a fragment of text displayed by the UI, such as a title of a section of the target document, a label of a menu item displayed by the UI, a default value of an input field, a placeholder value of an input field, and alternative text or text content of a tooltip displayed while hovering over a target element, among others. Other exemplary candidate labels, such as an element name, for instance, may be determined according to a source code and/or internal computer representation (e.g., HTML, DOM) of the respective target document. Some embodiments may then apply a set of heuristics to sort through multiple label candidates, for instance based on observations that a label is typically short (e.g., a few words), sits closest to the associated target element, and is typically aligned with the respective target element (e.g., directly on top, above, to the left, etc.).

Alternative embodiments may use artificial intelligence/machine learning to determine the target label. In one such example, step 710 may comprise taking a snapshot of at least a region of UI 37a including the user-selected target element, and transmitting the respective snapshot to a pre-trained AI/ML module for analysis. The respective module may form a part of AI modules 36 described in relation to FIG. 1 and may combine image processing with optical character recognition to determine the target label according to the received snapshot. In some embodiments, step 710 may further include displaying the detected target label to the user (as shown for instance in FIG. 9) for confirmation. When automatic label detection fails, the user may be invited to indicate a target label manually.

In a further step 712 some embodiments of robot design application 40 may receive user input further configuring various parameters of the selected RPA activity. In the example of an input field, step 712 may receive user input indicating a value to be filled into the respective input field at runtime. The respective value may be explicit (e.g., a user-provided text string) or may reference another data structure, possibly even including an output of another RPA activity of workflow 48.

The workflow design process may continue with the user selecting and configuring other RPA activities as shown above. When design of the current workflow is complete (a step 714 returns a YES), in a further step 716 some embodiments may formulate RPA package 50 of the current workflow, including computer-readable encodings of the selected RPA activity and target identification data such as a design-time target label determined in step 710.

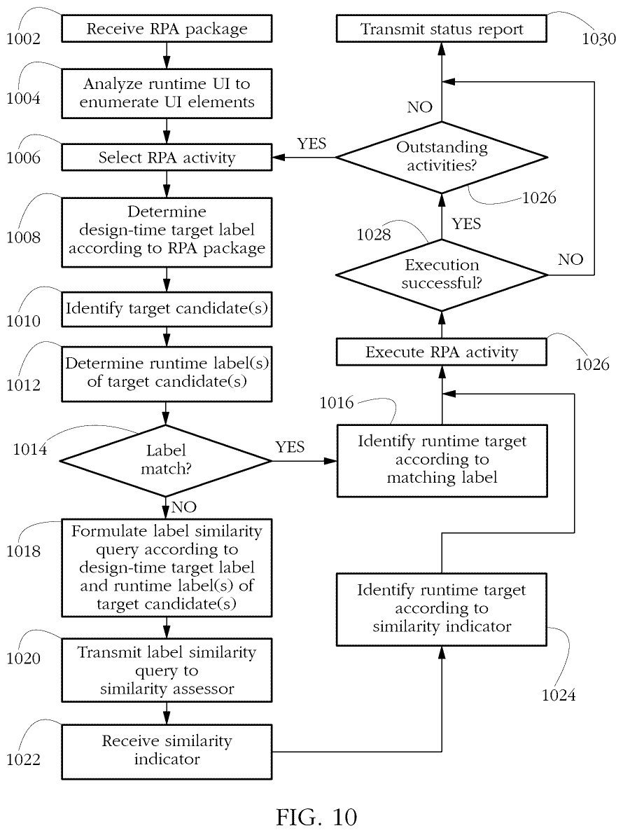

FIG. 10 shows an exemplary sequence of steps carried out by RPA robot 22 at runtime, according to some embodiments of the present invention. In a step 1002, robot 22 may receive RPA package 50 specifying a workflow for execution. Depending on embodiment, package 50 is received from RPA conductor 24 or directly from an instance of RPA design application 40, as described above. In a further step 1004, robot 22 may expose a runtime instance of the target UI, herein denoted as runtime UI 37b (see e.g., FIG. 5). In an exemplary use case scenario wherein the target UI comprises a web page, robot 22 may invoke an instance of a browser window and navigate to a target URL indicated in RPA package 50. Similar operations may expose runtime UI 37 in cases wherein the current workflow targets other kinds of applications (e.g., electronic communication applications, spreadsheet applications, etc.). Some embodiments then collaborate with RPA driver(s) 25 to analyze runtime UI 37, for instance to enumerate UI elements for identification as candidate targets for various RPA activities. In the example of a web page automation, step 1004 may comprise, for instance constructing and/or analyzing a DOM of the respective web page.

Some embodiments may then iterate through all RPA activities of the respective workflow as described in the received RPA package. A step 1006 may select an RPA activity from the workflow. The specification of the respective activity will typically include a set of target identification data enabling robot 22 to correctly identify a runtime instance of a target of the respective RPA activity. In a further step 1008, robot 22 may extract the design-time label of the respective target UI element from the target identification data. Such a label was included in RPA package at design time (see e.g., steps 710 and 716 in FIG. 7).

In a sequence of steps 1010-1012, robot 22 may then identify a set of candidate target elements within runtime UI 37b according to design-time target identification data such as the design-time target label. Step 1010 may include analyzing runtime UI 37 to identify a set of UI elements having the same type (e.g., input field) as the target of the current RPA activity. For each such candidate UI element, step 1012 may determine a runtime label, i.e., the label associated with the respective UI element within runtime UI 37b. Exemplary runtime labels include label 66b and the word ‘OK’ in UI 37b of FIG. 5. Determining runtime labels may comprise a similar procedure to that used at design-time to determine the design-time target label (see e.g., step 710 in FIG. 7).

A step 1014 may then determine if any of the runtime labels matches the design-time target label. When yes, in a step 1016 RPA robot 25 identifies the runtime target element as the target candidate whose runtime label exactly matches the label determined at design time.

When none of the runtime labels matches the design-time target label, some embodiments may identify the runtime target according to a similarity between the design-time target label and runtime labels. As illustrated in FIG. 6, some embodiments may transmit a label similarity query 72 to a semantic assessor 70 and in response, receive a similarity indicator 74 from assessor 70, indicator 74 determined according to similarity query 72 and quantifying a similarity between the design-time label of the target UI element and labels of runtime target candidates. In some embodiments, semantic assessor module 70 comprises a set of computer programs, which may execute locally on RPA client 12, or on a remote computer system. For instance, semantic assessor 70 may form a part of AI modules 36 (FIG. 1) and/or execute on AI/ML server 46 (FIG. 3). In alternative embodiments, some or all of assessor 70 may be implemented in dedicated hardware, or as a combination of hardware and software. A single instance of assessor module 70 may perform semantic similarity calculations for a plurality of RPA clients 12.

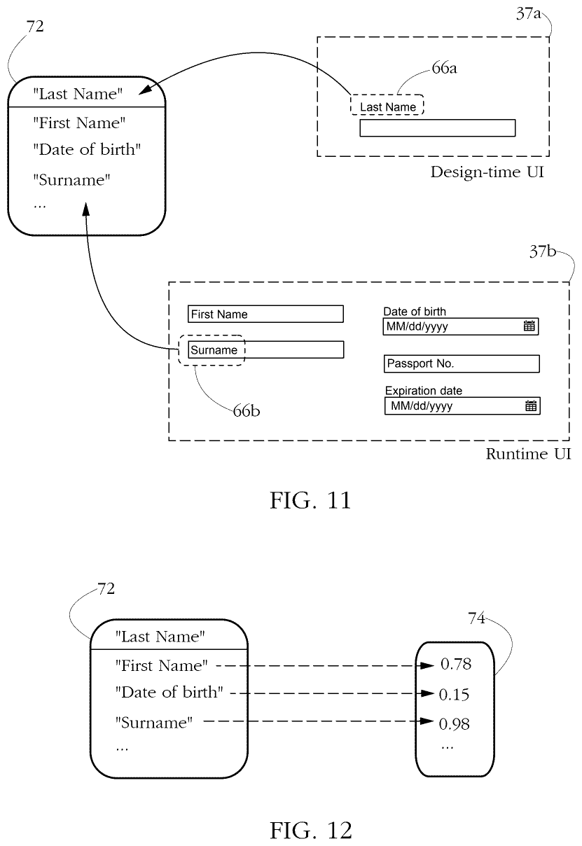

In a step 1018 robot 22 may formulate label similarity query 72. An exemplary query 72 according to some embodiments is illustrated in FIG. 11. Query 72 includes an encoding of design-time target label 66a, i.e., label associated with a target UI element in design-time UI 37a and included as target-identification data within RPA package 50. Query 72 further includes an encoding of at least one runtime label 66b, i.e., a label associated with a target candidate of runtime UI 37b. A skilled artisan will know that the format and content of query 72 may vary without departing from the scope of the present invention. Also, it will be clear that in alternative embodiments, design-time and runtime labels may be submitted in separate queries/data packages.

FIG. 12 shows an exemplary similarity indicator 74 according to some embodiments of the present invention. Similarity indicator 74 quantifies a semantic similarity between the design-time target label and each runtime label included in a respective label similarity query 72. In the illustrated example, indicator 74 comprises numbers ranging between 0 and 1, with 0 indicating no similarity and 1 indicating an exact match. However, the format and data type of indicator 74 may vary without departing from the scope of the present invention. Alternative exemplary indicators 74 may be Boolean, with YES indicating a match and NO indicating no semantic similarity, etc.

Semantic assessor 70 may use any method known in the art to evaluate a semantic similarity between design-time and runtime labels. Basic embodiments may use an annotated dictionary and/or thesaurus to determine whether two items are semantically similar (e.g., synonyms). Other embodiments may maintain a searchable database of natural language synsets, i.e., sets of words and phrases that are semantically similar to each other (e.g., last name, surname, and family name). One example of such a database developed for the English language is WordNet maintained by Princeton University in the US. Yet other embodiments may maintain a real-world collection of UI element labels and their runtime counterparts, for instance collected by instances of RPA robot 22 interacting with various target UIs. The respective labels may be organized according to element type (e.g., input field labels vs. button labels, etc.).

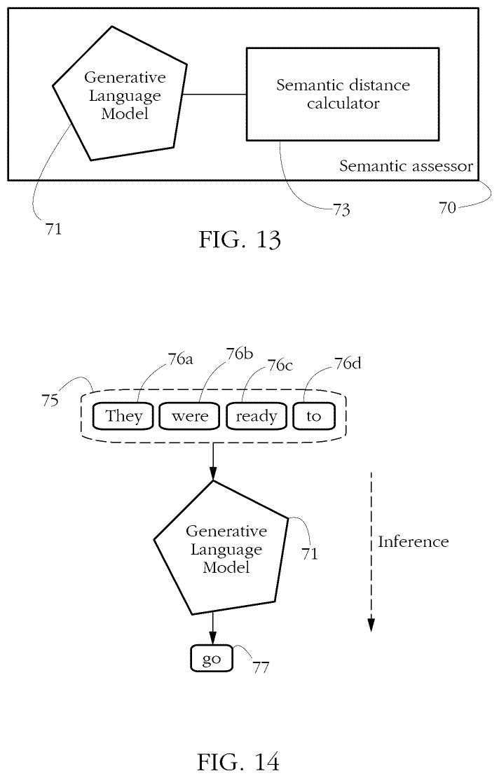

More sophisticated embodiments of semantic assessor 70 may rely on language models (LMs), which are computational, probabilistic models of a natural language. Examples include word n-gram models, skip-gram models, and large language models (LLMs), among others. FIG. 13 shows an exemplary semantic assessor 70 comprising a generative language model (GLM) 71 communicatively coupled to a semantic distance calculator 73. GLM 71 is herein deemed ‘generative’ in the sense that it is configured to input a sequence of words and in response, automatically generate another sequence of words comprising a plausible continuation of the input word sequence. GLM 71 may be implemented using any method known in the art of artificial intelligence. For instance, GLM 71 may comprise a set of artificial neural networks (e.g., recurrent neural networks, generative pre-trained transformers—GPT, etc.) trained on a corpus of text formulated in the respective natural language. In some embodiments, GLM 71 implements an instance of a pre-trained, off-the-shelf LLM such as GPT-3 from OpenAI, LLaMA from Meta AI, and Mistral from Mistral AI, among others. The structural and operational details of such models go beyond the scope of the present invention.

A basic operation of GLM 71 according to some embodiments of the present invention is illustrated in FIG. 14. GLM 71 receives a language model prompt 75 comprising a sequence of text tokens 76a-d, and in response, outputs a predicted text token 77 determined according to LM prompt 75, token 77 comprising a likely continuation of the sequence of tokens 76a-d of LM prompt 75. The set of calculations carried out by GLM 71 to produce an individual predicted token (not including the LM initialization steps described below) is commonly known in the art as an inference step. When the architecture of GLM 71 is based on neural networks, such calculations may comprise matrix multiplications and evaluating a set of activation functions, among others. Training such a GLM typically comprises selecting the input token sequence from a learning corpus consisting of actual text samples, comparing predicted token 77 with the actual continuation of the input sequence within the respective text sample, and adjusting a set of internal parameters of the GLM (e.g., neural synapse weights) with the aim of correcting wrong inferences. Modern GLMs typically have in the order or several hundreds of thousands to several billion adjustable parameters. Training may employ any machine learning algorithm known in the art, such as a version of backpropagation, among others.

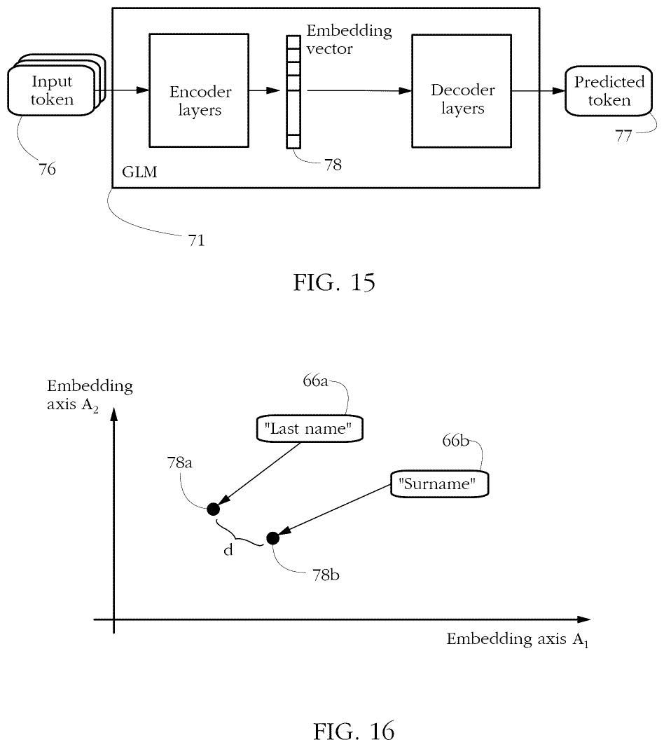

In some embodiments, GLM 71 comprises a sandwich of neural network layers as illustrated in FIG. 15, wherein a first set of layers act as an encoder receiving an input token 76 and outputting an internal representation of the respective token commonly known in the art as an embedding vector 78 or simply as an embedding. Embedding vector 78 comprises a set of numbers collectively amounting to a projection of token 76 in an abstract multi-dimensional space known as an embedding space. The coordinates of the embedding vector depend not only on the respective token, but also on the training corpus, since the parameters of the encoder layers are determined through training. Some embodiments produce a separate vector 78 for each input token of LM prompt 75. Another set of neural network layers then acts as a decoder, taking such embedding vectors 78 and transforming them to produce predicted token 77.

FIG. 16 shows an exemplary embedding space spanned by two abstract axes, and two embedding vectors 78a-b representing design-time target label 66a and runtime label 66b, respectively. A skilled artisan will know that the illustration is merely schematic and not limiting, since embedding spaces typically have thousands of dimensions. In some embodiments, semantic distance calculator 73 may calculate a similarity measure quantifying a semantic similarity between design-time and runtime labels according to the respective embedding vectors. In such embodiments, calculator 73 may receive an output of the encoder part of GLM 71 and evaluate the similarity measure according to a distance between embedding vectors representing the design-time target label and each runtime label of a target candidate. In the example illustrated in FIG. 16, the similarity measure between labels 66a-b may be determined according to a distance d separating vectors 78a-b in the embedding space. The distance may be calculated using any expression known in the art, for instance as an Euclidean distance, Manhattan distance, cosine distance, etc., or a combination thereof.

In some embodiments, in a sequence of steps 1020-1022 (FIG. 10), robot 22 may transmit label similarity query 72 to assessor module 70 and in response, receive similarity indicator 74 calculated according to query 72. In some embodiments as illustrated in FIG. 12, similarity indicator 74 may include a set of similarity measures, each similarity measure determined for a distinct runtime label and indicative of a similarity between the design time target label and a respective runtime label. Such similarity measures may be scaled so that values close to 1 indicate a strong similarity, while values close to 0 indicate no similarity. A step 1024 may identify the runtime target according to the content of similarity indicator 74. For instance, robot 22 may select as runtime target of the current RPA activity the element of runtime UI 37 whose runtime label is most similar to the design-time target label according to similarity indicator 74. Some embodiments may also implement an error-prevention strategy by comparing the received similarity indicator(s) to a pre-determined threshold and rejecting all target candidates having runtime labels with similarity measures below the threshold. When no runtime label is sufficiently similar to the design-time target label, some embodiments decide that the differences between design-time UI 37a and runtime UI 37b are too substantial for a safe continuation, suspend execution of the current workflow, and transmit a status report 55 informing on the error.

A step 1026 may then execute the respective RPA activity (e.g., click the identified button, fill in the identified input field, etc.). If the execution is successful (a step 1028 returns a YES), robot 22 may advance to the next RPA activity of the respective workflow. When all activities have been executed, a step 1030 may transmit status report 55, for instance to RPA conductor 24.

Some embodiments rely on the observation that semantic target identification as described herein is substantially more computationally expensive than conventional target identification for instance by matching a set of programmatic attribute-value pairs extracted from a DOM/UI tree. Reliable language models are relatively large and expensive to train and run. Furthermore, transmitting label similarity queries to a remote server inherently slows down target identification, impacting productivity and user experience. Therefore, to save computational resources and improve user experience, some embodiments may integrate semantic matching into an optimization strategy for target identification. In a first step, RPA robot 22 may attempt to identify the runtime target according to conventional methods. When such efforts fail, a second step may use semantic target identification as a fallback.

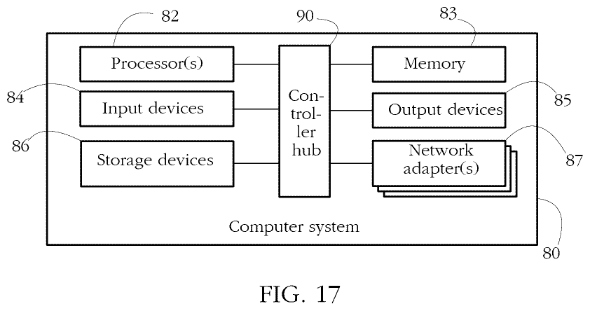

FIG. 17 shows an exemplary hardware configuration of a computer system 80 programmed to execute some of the methods described herein. Computer system 80 may represent any of RPA clients 12a-c, as well as RPA server(s) 32 or any other computer executing RPA robot 22 and/or semantic assessor module 70. The illustrated appliance is a personal computer; other computer systems such as servers, mobile telephones, tablet computers, and wearable computing devices may have slightly different configurations. Processor(s) 82 comprise a physical device (e.g. microprocessor, multi-core integrated circuit formed on a semiconductor substrate) configured to execute computational and/or logical operations with a set of signals and/or data. Such signals or data may be encoded and delivered to processor(s) 82 in the form of processor instructions, e.g., machine code. Processor(s) 82 may include a central processing unit (CPU) and/or an array of graphics processing units (GPU).

Memory unit 83 may comprise volatile computer-readable media (e.g. dynamic random-access memory—DRAM) storing data and/or instruction encodings accessed or generated by processor(s) 82 in the course of carrying out operations. Input devices 84 may include computer keyboards, mice, trackpads, and microphones, among others, including the respective hardware interfaces and/or adapters allowing a user to introduce data and/or instructions into computer system 80. Output devices 85 may include display devices such as monitors and speakers among others, as well as hardware interfaces/adapters such as graphic cards, enabling the respective computing device to communicate data to a user. In some embodiments, input and output devices 84-85 share a common piece of hardware (e.g., a touch screen). Storage devices 86 include computer-readable media enabling the non-volatile storage, reading, and writing of software instructions and/or data. Exemplary storage devices include magnetic and optical disks and flash memory devices, as well as removable media such as CD and/or DVD disks and drives. Network adapter(s) 87 include mechanical, electrical, and signaling circuitry for communicating data over physical links coupled to an electronic communication network (e.g, FIG. 1) and/or to other devices/computer systems. Adapter(s) 87 may be configured to transmit and/or receive data using a variety of communication protocols.

Controller hub 90 generically represents the plurality of system, peripheral, and/or chipset buses, and/or all other circuitry enabling the communication between processor(s) 82 and the rest of the hardware components of computer system 80. For instance, controller hub 90 may comprise a memory controller, an input/output (I/O) controller, and an interrupt controller. Depending on hardware manufacturer, some such controllers may be incorporated into a single integrated circuit, and/or may be integrated with processor(s) 82. In another example, controller hub 90 may comprise a northbridge connecting processor 82 to memory 83, and/or a southbridge connecting processor 82 to devices 84, 85, 86, and 87.

The exemplary systems and methods described above facilitate UI automation by improving the automatic identification of activity targets, i.e., UI elements acted upon by robotic software. Target identification poses a substantial technical problem because in many RPA applications the functionality and/or appearance of the target UI may change suddenly in ways which are beyond the control of robot designers. Some exemplary changes between design-time and runtime often encountered in real-life applications are shown in FIG. 5. Some UI elements may be removed, others may be re-positioned within the target UI. The composition of a menu may change, as well as an order and a labeling of individual menu items. Element attributes such as colors, fonts, labels, etc., may change. In conventional RPA, a robot is typically trained to recognize an activity target (e.g., a button to click, an input field to fill out) according to such characteristics, and therefore any changes in such characteristics may cause the respective automation to fail.

Some embodiments of the present invention directly address such shortcomings, while simultaneously facilitating robot design. At design time, a robot design interface enables an automation designer to indicate a target UI element, and in response, automatically identifies a text label associated with the respective target. The design-time target label is then included in a computer-readable specification of the respective workflow and transmitted to the RPA robot for execution. At runtime, the robot may search for a target having the indicated design-time label. When no such target can be found within the runtime instance of the target UI, some embodiments assemble a set of target candidates partially matching the design-time attributes of the respective target, and automatically determine a runtime text label associated with each such candidate. Some embodiments then identify the runtime target according to a semantic similarity (likeness in meaning, as opposed to wording) between the design-time label of the target and the labels of the runtime target candidates.

In evaluating semantic similarity, some embodiments benefit from the recent progress in natural language processing, and especially the advent of language models based on a transformer architecture (e.g. GPT from Open AI, Inc.). A measure of semantic similarity may be computed for instance according to a distance separating the design-time label and runtime label in an embedding space constructed by an LM. Even though language models are typically expensive to train and operate, some embodiments rely on the observation that UI labels are relatively compact and therefore semantically comparing them does not require the largest or most sophisticated LMs. Instead, computer experiments have revealed that successful semantic target identification may be carried out by small size, even portable LMs that can execute locally on the respective RPA client. Such small LMs may be developed and trained deliberately for semantic similarity measurements, and then incorporated into software distributions to clients.

By closely mimicking the way a human solves the problem of encountering unexpected changes in a familiar interface, some embodiments of the present invention manage to prevent a vast majority of target identification failures. A particular advantage of semantic target identification as described herein is that it allows using many types of text content (e.g., an actual label, a placeholder or default value of an input field, an alternative text/tooltip) as labels for semantic similarity evaluations. In a specific example illustrated in FIG. 5, not only the wording of the label changes (e.g., from ‘Last Name’ to ‘Surname’), but also the type of the element effectively acting as a label changes. Whereas design-time label 66a is a plain text element, label 66b is a default or placeholder value of the respective input field. Programmatic characteristics of the runtime target thus differ substantially from those of the design-time target, which did not have a default/placeholder value. In an even more extreme example, runtime UI 37b may display mock passenger data as placeholder values of the respective input fields (e.g., ‘Bart’ and ‘Simpson’ in place of the illustrated ‘First Name’ and ‘Surname’, respectively). Some conventional UI automation systems may not recognize such items as labels of the respective field, and even if they do, they may not be able to match the runtime label ‘Simpson’ or ‘Surname’ to the design-time label ‘Last Name’. In contrast, in some embodiments of the present invention semantic targeting comprises interpreting both items 66a-b as merely text labels and identifying the runtime target primarily according to a semantic similarity of the respective labels, thus overcoming the above-mentioned obstacles. In the example of mock passenger names, some embodiments of the present invention can determine for instance that ‘Simpson’ is semantically more similar to ‘Last Name’ than to ‘First Name’ or ‘Gender’.

The disclosure and exemplary embodiments illustrated above have focused on just two types of targets: input fields and buttons (e.g., items 64e and 64f in FIG. 5, respectively). However, the systems and methods described herein may equally be used to semantically identify other kinds of target UI elements. Examples include section headers and titles, whole menus, individual menu items (e.g., as exposed by unrolling a drop-down menu), and practically all hyperlinked elements of a target UI. In the example of a hyperlinked text (see e.g., item 64e in FIG. 4), the respective anchor text may be used as a label for semantic similarity evaluations. When the target hyperlinked element does not naturally display a label (as in the case of icon 64b in FIG. 4, for example), some embodiments may use a content of an alternative text or tooltip displayed when hovering over the respective target element.

Beside efficiently identifying runtime activity targets, some embodiments substantially simplify robot design. Conventional RPA typically requires specialized knowledge of RPA software and user interfaces (e.g., HTML, JavaScript®, SAP®, etc.), as well as substantial design experience. To design a successful RPA workflow, an automation designer must be able to predict or know from experience how a UI is likely to change in the future, and how to tweak target identification strategies according to the type and appearance of the target UI. For instance, some conventional RPA systems allow the designer to explicitly select a subset of target attributes (e.g., selected attribute-value pairs from a DOM of a target web page) to be used at runtime. An experienced designer will know which target attributes are less likely to change in the future and are therefore more robust target identifiers. In contrast, some embodiments of the present invention merely require that the designer indicate the target element, thus lowering the access threshold for developers lacking specialized skills.

Some embodiments further improve RPA design by including semantic targeting as an additional, complementary tool in the automation designer's toolbox. In an exemplary robot design interface, semantic targeting activities may be included as separate items on a menu of available RPA activities alongside RPA activities that use conventional target identification, thus giving the automation designer freedom to choose between semantic and conventional target identification according to a type and appearance of the target UI. Alternatively or additionally, semantic target identification may be incorporated into existing target identification methods as a fallback strategy, for situations where conventional methods fail.

It will be clear to one skilled in the art that the above embodiments may be altered in many ways without departing from the scope of the invention. Accordingly, the scope of the invention should be determined by the following claims and their legal equivalents.

1. A computer system comprising at least one hardware processor configured to:
receive an encoding of a robotic process automation (RPA) activity and an encoding of a design-time target label, wherein the RPA activity mimics a human interaction with a target element of a user interface (UI), and wherein the design-time target label comprises a text label attached to the target element within a design-time instance of the UI;
in response, identify a runtime instance of the target element within a runtime instance of the UI exposed by the computer system, the runtime instance of the target element identified according to a similarity between a meaning of the design-time target label and a meaning of a label attached to the runtime instance of the target element; and
in response to identifying the runtime instance of the target element, execute the RPA activity on the runtime instance of the target element.

2. The computer system of claim 1, wherein identifying the runtime instance of the target element comprises:
selecting a candidate target element from the runtime instance of the UI;
automatically determining a candidate label comprising another text label attached to the candidate target element within the runtime instance of the UI;
transmitting the design-time target label and candidate label to a semantic assessor module;
receiving from the semantic assessor module a similarity measure quantifying a similarity between the meaning of the design-time target label and a meaning of the candidate label; and
determining whether the runtime instance of the target element comprises the candidate target element according to the similarity measure.

3. The computer system of claim 2, wherein identifying the runtime instance of the target element further comprises:
selecting a second candidate target element from the runtime instance of the UI;
automatically determining a second candidate label comprising yet another text label attached to the second candidate target element within the runtime instance of the UI;
transmitting the second candidate label to the semantic assessor module;
receiving from the semantic assessor module a second similarity measure quantifying a similarity between the meaning of the design-time target label and a meaning of the second candidate label; and
determining whether the runtime instance of the target element comprises the candidate target element further according to the second similarity measure.

4. The computer system of claim 2, wherein identifying the runtime instance of the target element comprises comparing the similarity measure to a pre-determined threshold and determining whether the runtime instance of the target element comprises the candidate target element according to a result of the comparison.

5. The computer system of claim 2, wherein the semantic assessor module is configured to employ a pre-trained generative language model (GLM) to determine the similarity measure.

6. The computer system of claim 5, wherein determining the similarity measure comprises:
employing the GLM to determine a first embedding vector of the design-time target label and a second embedding vector of the candidate label; and
determining the similarity measure according to a distance between the first and second embedding vectors.

7. The computer system of claim 1, wherein:
the target element comprises an input field of the UI;
the RPA activity comprises filling out the input field; and
the label attached to the runtime instance of the target element is determined according to a placeholder value of the input field, the placeholder value displayed by the runtime instance of the UI.

8. The computer system of claim 1, wherein the target element comprises an item selected from a set consisting of a button of the UI, a menu item of the UI, and a hyperlinked element of the UI, and wherein the RPA activity comprises clicking or tapping the item.

9. The computer system of claim 1, wherein:
the target element comprises a hyperlinked element of the UI; and
the at least one hardware processor is configured to determine the label attached to the runtime instance of the target element according to an alternative text or tooltip displayed by the runtime instance of the UI when hovering over the runtime instance of the target element.

10. A computer-implemented robotic process automation (RPA) method comprising employing at least one hardware processor configured to:
receive an encoding of an RPA activity and an encoding of a design-time target label, wherein the RPA activity mimics a human interaction with a target element of a user interface (UI), and wherein the design-time target label comprises a text label attached to the target element within a design-time instance of the UI;
in response, identify a runtime instance of the target element within a runtime instance of the UI exposed by the computer system, the runtime instance of the target element identified according to a similarity between a meaning of the design-time target label and a meaning of a label attached to the runtime instance of the target element; and
in response to identifying the runtime instance of the target element, execute the RPA activity on the runtime instance of the target element.

11. The method of claim 10, wherein identifying the runtime instance of the target element comprises:
selecting a candidate target element from the runtime instance of the UI;
automatically determining a candidate label comprising another text label attached to the candidate target element within the runtime instance of the UI;
transmitting the design-time target label and candidate label to a semantic assessor module;
receiving from the semantic assessor module a similarity measure quantifying a similarity between the meaning of the design-time target label and a meaning of the candidate label; and
determining whether the runtime instance of the target element comprises the candidate target element according to the similarity measure.

12. The method of claim 11, wherein identifying the runtime instance of the target element further comprises:
selecting a second candidate target element from the runtime instance of the UI;
automatically determining a second candidate label comprising yet another text label attached to the second candidate target element within the runtime instance of the UI;
transmitting the second candidate label to the semantic assessor module;
receiving from the semantic assessor module a second similarity measure quantifying a similarity between the meaning of the design-time target label and a meaning of the second candidate label; and
determining whether the runtime instance of the target element comprises the candidate target element further according to the second similarity measure.

13. The method of claim 11, wherein identifying the runtime instance of the target element comprises comparing the similarity measure to a pre-determined threshold and determining whether the runtime instance of the target element comprises the candidate target element according to a result of the comparison.

14. The method of claim 11, wherein the semantic assessor module is configured to employ a pre-trained generative language model (GLM) to determine the similarity measure.

15. The method of claim 14, wherein determining the similarity measure comprises:
employing the GLM to determine a first embedding vector of the design-time target label and a second embedding vector of the candidate label; and
determining the similarity measure according to a distance between the first and second embedding vectors.

16. The method of claim 10, wherein:
the target element comprises an input field of the UI;
the RPA activity comprises filling out the input field; and
the label attached to the runtime instance of the target element is determined according to a placeholder value of the input field, the placeholder value displayed by the runtime instance of the UI.

17. The method of claim 10, wherein the target element comprises an item selected from a set consisting of a button of the UI, a menu item of the UI, and a hyperlinked element of the UI, and wherein the RPA activity comprises clicking or tapping the item.

18. The method of claim 10, wherein:
the target element comprises a hyperlinked element of the UI; and
the method comprises employing the at least one hardware processor to determine the label attached to the runtime instance of the target element according to an alternative text or tooltip displayed by the runtime instance of the UI when hovering over the runtime instance of the target element.

19. A non-transitory computer-readable medium storing instructions which, when executed by at least one hardware processor of a computer system, cause the computer system to:
receive an encoding of a robotic process automation (RPA) activity and an encoding of a design-time target label, wherein the RPA activity mimics a human interaction with a target element of a user interface (UI), and wherein the design-time target label comprises a text label attached to the target element within a design-time instance of the UI;
in response, identify a runtime instance of the target element within a runtime instance of the UI exposed by the computer system, the runtime instance of the target element identified according to a similarity between a meaning of the design-time target label and a meaning of a label attached to the runtime instance of the target element; and
in response to identifying the runtime instance of the target element, execute the RPA activity on the runtime instance of the target element.
